(19) United States
(12) Patent Application Publication
(10) Pub. No.: US 2024/0278580 A1
(43) Pub. Date: Aug. 22, 2024

(54) SMALL FORM FACTOR PRINT HEAD AND PRINTER

(71) Applicant: Funai Electric Co., Ltd., Osaka (JP)

(72) Inventors: Andrew L. MCNEES, Lexington, KY (US); Sean T. Weaver, Lexington, KY (US)

(73) Assignee: Funai Electric Co., Ltd., Osaka (JP)

(21) Appl. No.: 18/171,478

(22) Filed: Feb. 20, 2023

(51) Int. Cl. B41J 2/175

(52) U.S. Cl. CPC B41J 2/17563

(57) ABSTRACT

A small form factor printhead and a thermal ink jet printer containing the reduce form factor printhead. The printhead includes an ink reservoir body having four side walls connected to a bottom wall. An ink supply port is disposed in the bottom wall. An ejection head is attached to an exterior surface of the bottom wall, wherein the ejection head is in ink flow communication with the ink supply port. A flexible circuit is electrically connected to the ejection head and is attached to the exterior surface of the bottom wall and an exterior surface of one of the four side walls. A cover is attached to a distal end of the four side walls opposite the bottom wall. A filter is attached adjacent to an underside of the cover.

### TECHNICAL FIELD

The disclosure is directed to an ejection head for high volume printing and in particular to a continuous thermal ink jet printhead having improved vapor handling characteristics.

### BACKGROUND AND SUMMARY

For industrial printing applications, goods are typically marked continuously on the production line with indicia such as expiration dates, lot numbers, batch numbers, bar codes, and the like. This allows batch and production tracking of the goods. Product marking is particularly important in the food and pharmaceutical industries. However, the real estate area allotted to a production line in the food and pharmaceutical industries is typically limited and thus extremely valuable. Accordingly, it is advantageous to have the printing head or ink ejection device occupy limited space along the production line and to be positioned as close as possible to the substrate being marked.

Continuous ink jet (CIJ) printers containing CIJ printheads are commonly used in high production industries due to their ability to be positioned close to the substrate without taking up much valuable real estate. However, CIJ printers are costly, require significant maintenance, and are limited in the resolution and quality of the printed images. Most CIJ printheads provide dot matrix indicia with very low image resolution such as 50 to 170 dots per inch (dpi).

Thermal ink jet (TIJ) printheads are also commonly used in various industrial printing applications. TIJ printheads are typically less costly than CIJ printheads, provide much higher print resolution than CIJ printheads, such as up to 2400 dpi or more and are more easily replaced or maintained compared to CIJ printheads. However, conventional TIJ printheads are typically bulkier than the corresponding CIJ printheads and as such require more valuable space along the production line than the CIJ printheads. This makes the use of conventional TIJ printheads less desirable for use in the food and pharmaceutical industries.

In order for a TIJ printhead to function continuously and efficiently in a high production setting, air management within the TIJ printhead is vital. Excessive vapor accumulating within the fluid reservoir body of the conventional TIJ printhead adjacent to the fluid ejection head is frequently the cause of poor printing performance, maintenance downtime, and/or failure of the TIJ printhead. A conventional TIJ printhead 10 is illustrated in FIGS. 1 and 2 and includes an ink reservoir body 12. The printhead 10 also includes a filter 14 attached to a filter tower 16 as well as a backpressure device 18. The backpressure device 18 is in fluid contact with the filter 14 to provide flow of ink 20 to an ejection head 22. Accordingly, as shown in FIGS. 1 and 2 the prior art printhead 10 has only a small volume of ink 20 located in the filter tower 16 that is adjacent to the ejection head 22. The small volume of ink 20 in the filter tower 16 is readily replenished from the ink impregnated backpressure device 18, such as a foam or felt, disposed in the ink reservoir body 12. The backpressure device 18 prevents drooling of ink from the ejection head 22 by maintaining a backpressure on the ink that flows through the filter 14 into the filter tower 16. Because of the small volume of ink in the filter tower 16, under continuous printing operations, a vapor space is likely to accumulate in the filter tower 16 impeding the flow of ink from the backpressure device 18 through the filter and filter tower 16 and into the ejection head 22.

Another disadvantage of the prior art printhead 10 for a continuous TIJ printing is the rather large size of the printhead 10 relative to the size of the printhead for CIJ printing. Reducing the size or bulkiness of the TIJ printhead 10 would only result in a smaller volume of ink in the reservoir body 12 without improving an ink to vapor ratio within the printhead thus leading to increased air management problems. Accordingly, what is needed is a small form factor TIJ printhead that has improved air management properties during continuous printing operations.

In view of foregoing, an embodiment of the disclosure provides a small form factor printhead. The printhead includes an ink reservoir body having four side walls connected to a bottom wall. An ink supply port is disposed in the bottom wall. An ejection head is attached to an exterior surface of the bottom wall, wherein the ejection head is in ink flow communication with the ink supply port. A flexible circuit is electrically connected to the ejection head and is attached to the exterior surface of the bottom wall and an exterior surface of one of the four side walls. A cover is attached to a distal end of the four side walls opposite the bottom wall. A filter is attached adjacent to an underside of the cover.

In some embodiments, an ink reservoir refill port is disposed in the cover.

In some embodiments, the filter is adhesively attached to the inside surface of the cover. In some embodiments, the filter is attached to the four side walls opposite the bottom wall. In other embodiments, the filter is welded to the inside surface of the cover.

In some embodiments, the filter is selected from a stainless steel mesh, a porous membrane, a random weave polymeric web, a mesh polymeric web, and a polymeric felt.

In some embodiments, the ink reservoir is devoid of a backpressure device. In other embodiments, the ink reservoir is devoid of a filter tower structure.

In some embodiments, the ink reservoir has a total ink volume ranging from about 4 mL to about 25 mL.

In some embodiments, the ejection head has an ejector array length ranging from about 2 millimeters to about 25 millimeters.

In another embodiment there is provided a thermal ink jet printer. The thermal ink jet printer includes a small form factor printhead having an ink reservoir body having four side walls connected to a bottom wall, an ink supply port in the bottom wall, an ejection head attached to an exterior surface of the bottom wall, wherein the ejection head is in ink flow communication with the ink supply port, a flexible circuit electrically connected to the ejection head and attached to the exterior surface of the bottom wall and an exterior surface of one of the four side walls, a cover attached to a distal end of the four side walls opposite the bottom wall, a filter attached adjacent to an underside of the cover, and a ink reservoir refill port attached to an exterior surface of the cover. The thermal ink jet printer also includes a bulk ink supply tank in fluid flow communication with the ink reservoir refill port and a printhead controller in electrical communication with the small form factor printhead.

In some embodiments, the thermal ink jet printer two or more stationary small form factor printheads adjacent to a movable substrate, wherein the two or more stationary printheads are configured for printing on the movable substrate.

In some embodiments, each of the two or more stationary small form factor printheads have an ink reservoir having a total ink volume ranging from about 4 mL to about 25 mL.

In some embodiments, each of the two or more stationary small form factor printheads has an ejector array length ranging from about 2 millimeters to about 25 millimeters.

In some embodiments, the filter is selected from the group consisting of a stainless steel mesh, a porous membrane, a random weave polymeric web, a mesh polymeric web, and a polymeric felt.

In another embodiment there is provided a small form factor printhead having an ink reservoir body having an internal void volume ranging from about 4 mL to about 25 mL. A top cover is attached to the ink reservoir body, wherein the top cover has a fluid fill port therein. A bottom wall is attached to the ink reservoir body on a distal end of the ink reservoir body from the top cover. The bottom wall has an ink supply port therein. An ejection head is attached to an exterior surface of the bottom wall. The ejection head is in ink flow communication with the ink supply port. A flexible circuit is electrically connected to the ejection head and attached to the exterior surface of the ink reservoir body. A filter is attached adjacent to an underside of the top cover.

An advantage of the disclosed embodiments is that a much smaller ink reservoir may be provided without reducing the effectiveness of the air management system within the ink reservoir. Accordingly, even in the absence of a backpressure device within the ink reservoir body, a continuous flow of ink to the ejection head is provided by relocating the ink filter to adjacent to the cover so that the entire ink reservoir can effectively be filled with ink. Thus, a filter tower structure adjacent to an ink feed slot of the ejection head is not needed for the small form factor printhead disclosed herein. Other benefits and advantages may be evident by reference to the attached drawings in combination with the following detailed description.

### BRIEF DESCRIPTION OF THE DRAWINGS

FIG. 1 is a cross-sectional, side view, not to scale, of a prior art printhead.

FIG. 2 is a cross-sectional, front view, not to scale of the printhead of FIG. 1.

FIG. 3 is a top perspective view of a TIJ printhead according to an embodiment of the disclosure.

FIG. 4 is a bottom perspective view of the TIJ printhead of FIG. 3.

FIG. 5 is an underside plan view of a cover for the TIJ printhead of FIG. 3.

FIG. 6 is a plan view of a filter attached to the underside of the cover of FIG. 5.

FIG. 7 is a front cross-sectional view, not to scale, of the TIJ printhead of FIG. 3.

FIG. 8 is a side cross-sectional view, not to scale, of the TIJ printhead of FIG. 3.

FIG. 9 is a front cross-sectional view, not to scale, of a TIJ printhead according to another embodiment of the disclosure.

FIG. 10 is a schematic illustration of a continuous ink jet printer containing multiple TIG printheads according to an embodiment of the disclosure.

FIG. 11 is a bottom plan view, not to scale, of a TIJ printhead according to an embodiment of the disclosure.

FIG. 12 is a bottom plan view, not to scale, of multiple TIJ printheads according to an embodiment of the disclosure.

FIG. 13 is a bottom perspective view of an ink reservoir body for a TIJ printhead according to the disclosure.

FIG. 14 is a bottom perspective view of the ink reservoir body of FIG. 13 containing a stiffener insert according to an embodiment of the disclosure.

### DETAILED DESCRIPTION

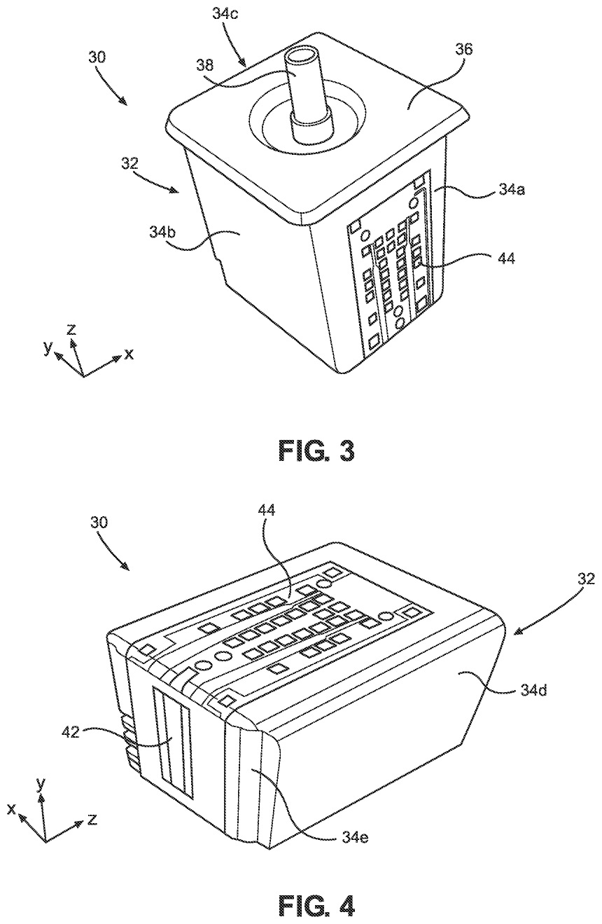

For the purposes of this disclosure, the term “small form factor” refers to an ink reservoir body having an internal void volume that is sufficient to hold from about 4 mL to about 25 mL or more of ink in the absence of a backpressure device and/or filter tower structure. The term “printhead” as used herein refers to the ink reservoir body having an ejection head, a flexible circuit attached to the ejection head, a cover for the reservoir body, an internal filter attached adjacent to the cover, and an ink refill port in the cover. The term “thermal ink jet (TIJ) printer” refers to a printer console having an ink supply reservoir therein, a conduit for providing ink to the printhead from the ink supply reservoir and a controller for activating the printhead. An illustration of a small form factor printhead 30 is illustrated FIGS. 3 and 4.

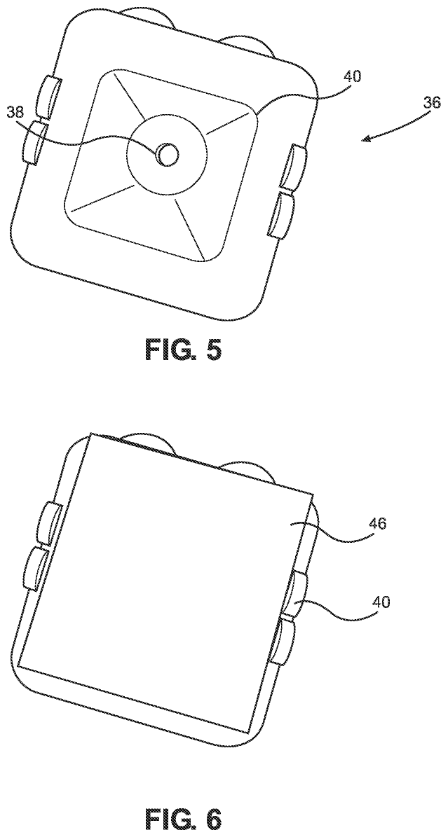

The small form factor printhead 30 includes an ink reservoir body 32 having one or more sidewalls, such as four sidewalls 34a-34d, and a bottom wall 34e. A cover 36 is attached to the four side walls 34a-34d to provide a closed ink reservoir within the ink reservoir body 32. In some embodiments, the ink reservoir body has a cylindrical shape having a bottom wall and a cover. A variety of other shapes may be used for the ink reservoir body provided the shape of the reservoir body provides the small form factor described herein. The ink reservoir body 32 may be made of a variety of materials including, but not limited to, sintered powder metal, ceramic, nylon, polyethylene terephthalate (PET) and the like. Ink is supplied to the ink reservoir body 32 continuously or intermittently through an ink refill port 38 attached to the cover 36. The cover 36 may also be made from a variety of materials including, but not limited to, sintered powder metal, ceramic, nylon, polybutylene terephthalate (PBT) and the like. The ink refill port 38 may have a barbed connector or a tube may be inserted through an opening in the cover 36 to provide the ink refill port 38. An underside 40 of the cover 36 is illustrated in FIG. 5 showing the ink refill port 38. An ejection head 42 is attached to the bottom wall 34e of the ink reservoir body 32. A flexible circuit 44 is electrically connected to the ejection head 42, bottom wall 34e and side wall 34a to provide activation of the ejection head 42 during a printing operation.

The overall size of the ink reservoir body 32 is reduced compared to a conventional TIJ printhead 10 in order to allow just enough area for the ejection head 42 and flexible circuit 44 to be attached to the ink reservoir body 32 as shown in FIG. 4. In some embodiments, the ink reservoir body 32 has an internal ink volume ranging from about 4 mL to about 25 mL. In some embodiments the internal volume of the ink reservoir body 32 is devoid of any filter tower structure or any backpressure device. Accordingly, in some embodiments, the entire internal volume of the ink reservoir body 32 may be filled with ink as described in more detail below. In other embodiments, an internal backpressure device such as foam, felt, a bladder, or other backpressure device may be included in the reservoir body 32, if desired.

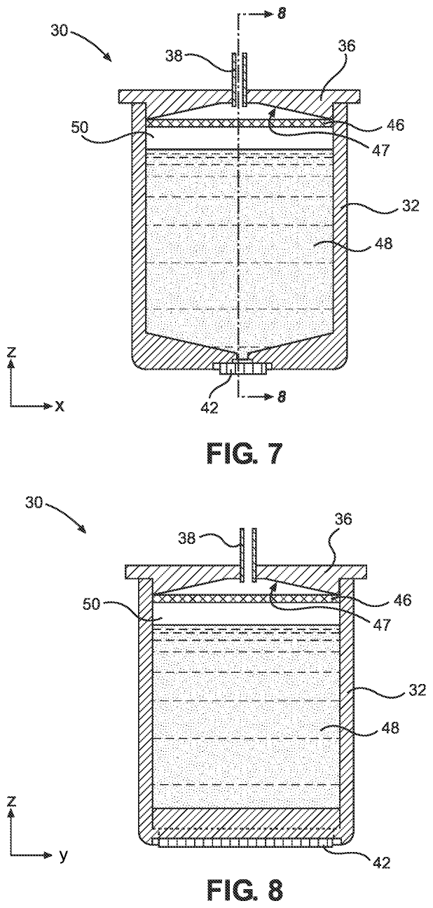

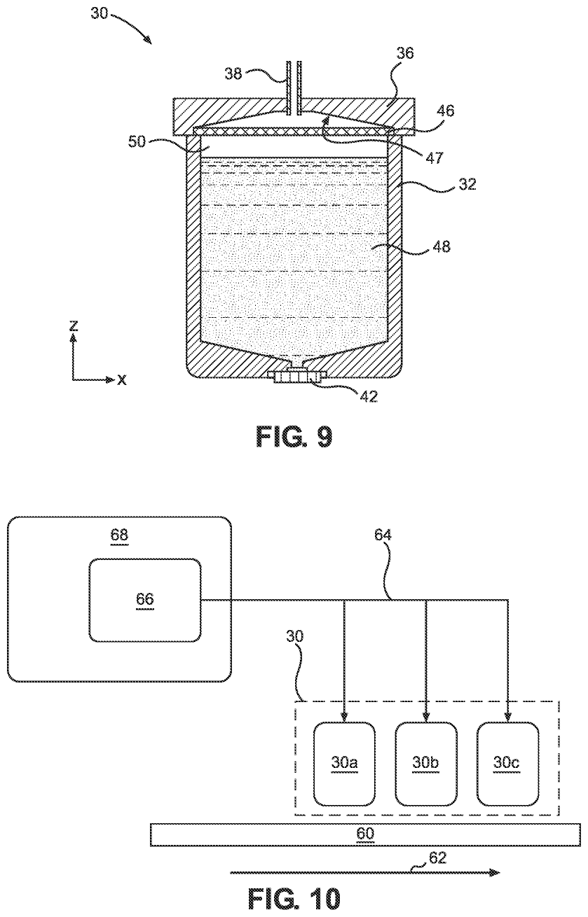

An important feature of the small form factor printhead 30 is placement of a filter 46 (FIG. 6) that is incorporated in the printhead 30 to prevent particles from clogging micro-scale flow features of the ejection head 42. In one embodiment, illustrated in FIGS. 6-8, the filter 46 is attached directly to a portion of the inside surface 47 of the cover 36 by an adhesive, by welding, or by heat staking the filter to a periphery of the inside surface of the cover 36. In another embodiment, the filter 46 is attached to the side walls 34a-34d of the ink reservoir body 32 opposite the bottom wall 34e, as illustrated in FIG. 9 by welding or by an adhesive. Regardless of how the filter 46 is attached to the printhead 30, it is evident that the ink reservoir body 32 is configured to provide a substantially increase amount of ink 48 in the ink reservoir body 32 above the ejection head 42 so that a ratio of ink 48 to vapor space 50 is increased. Thus, the printhead 30 can accommodate a larger volume of vapor without impeding the flow of ink to the ejection head 42 compared to the prior art printhead 10 which only has a relatively small volume of ink in the filter tower 16 adjacent to the ejection head 22. Accordingly, embodiments of the disclosure have an ink 48 to vapor space 50 ratio that is much greater than an ink to vapor space ratio provided by the conventional printhead 10. Having a larger ratio of ink 48 to vapor space 50 also improves cooling of the ejection head 42. A preferred ink to vapor space volume percent ranges from about 0% to about 50%.

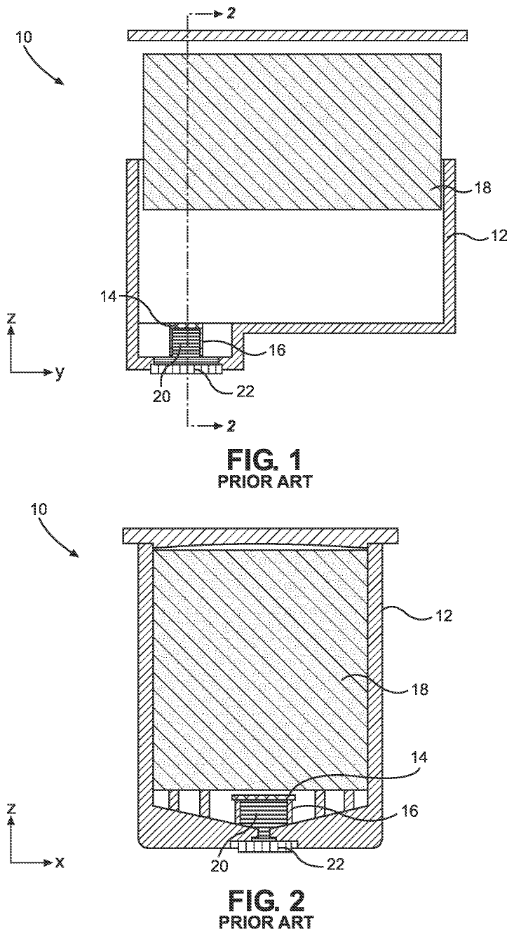

Another important feature of the filter 46 is that a surface area for filtering provided by the filter 46 may be substantially greater than a surface area provided by the prior art filter 14 since the filter 46 is not positioned on a filter tower 16 (FIG. 1A) as in the prior art printhead 10. Accordingly, refilling of the ink reservoir body 32 is enhanced by the unique design of the printhead 30 which allows for a larger volume of ink to be adjacent to the ejection head compared to the volume of ink in the filter tower 16 of the prior art printhead 10. In the embodiments wherein the filter 46 is attached to the inside surface 47 of the cover 36, or to the side walls 34a-34d, the inside surface 47 of the cover may have a concave shape that is configured to allow a volume of ink 48 between the filter 46 and the cover 36 as shown in FIG. 9.

In the embodiments described above, the filter 46 may be made of a variety of materials that are compatible with the ink. Accordingly, the filter 46 may be a stainless steel wire mesh filter, a PET track-etched membrane filter, a woven, non-woven, or random weave PET filter, or a polyethylene/polypropylene felt filter may be used. In some embodiments, an external filter attached to an ink refill supply line to the refill port 38 of the printhead 30 may be used instead of the internal filter 46 or in addition to the internal filter 46.

FIG. 10 illustrates a continuous printer containing two or more stationary printheads 30 disposed above a substrate 60 moving in the direction of arrow 62. An ink supply conduit 64 provides a resupply of ink to the printheads 30a-30c from a bulk ink supply tank 66 located in a printer console 68.

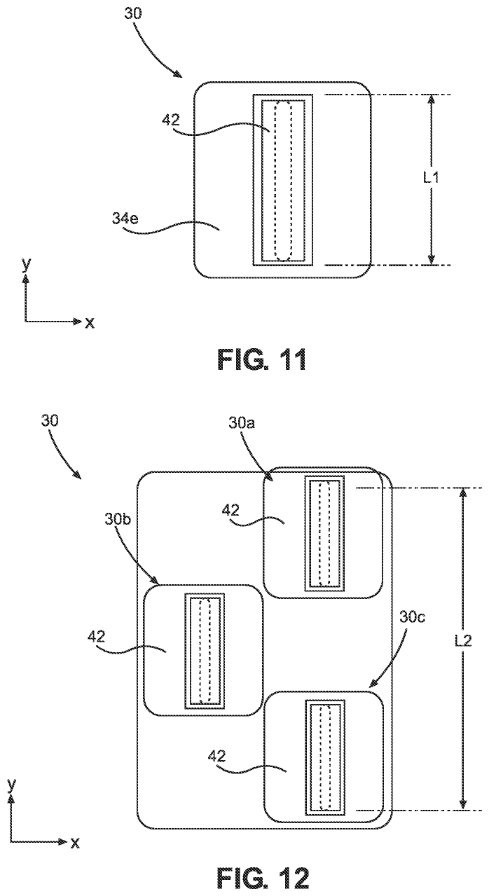

As shown in FIG. 11, each ejection head 42 has a swath length L1 ranging from about 2 millimeters to about 25 millimeters. In order to increase the swath length, multiple printheads 30a-30c may be combined to give an overall swath length L2 that ranges from about 21 to about 60 millimeters or more as shown in FIG. 12.

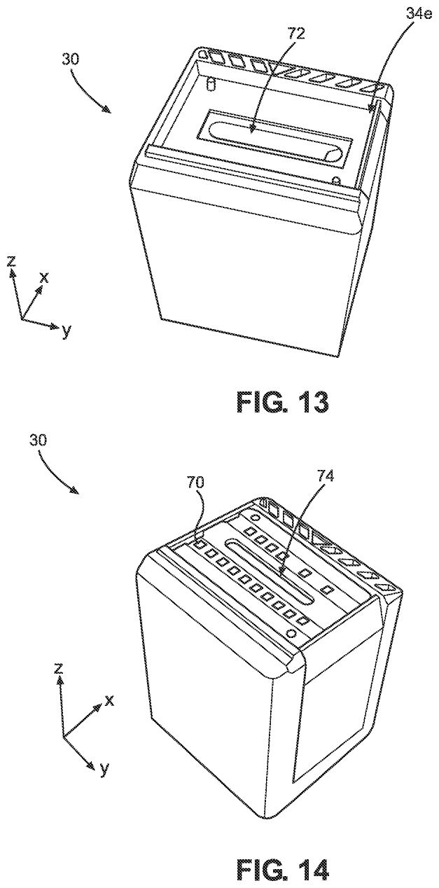

It will be appreciated that there is a practical limit to the size of the ejection head 42. Larger ejection heads 42 tend to be more prone to breakage during the manufacturing process and in use. Accordingly, in some embodiments, an ejection head stiffener insert 70 may be attached to the bottom wall 34e as shown in FIGS. 13 and 14. Both the bottom wall 34e and the stiffener insert 70 include an ink supply port 72 and 74, respectively, for providing ink to the ejection head 42. In some embodiments, the stiffener insert 70 is made of ceramic. In other embodiments the stiffener insert 70 is made of an anodized aluminum or a metal that includes an inert coating to prevent flocculation of solids from fluids ejected by the ejection head 42. The stiffener insert 70 provides additional robustness to the ejection head 42 by limiting stresses caused by coefficient of thermal expansion (CTE) mismatch between the ejection head material and the reservoir body material, breakage caused by impact between the ejection head and a hard surface, and other forces that could result in a broken ejection head.

The TIJ printhead 30 described herein provides a large volume of ink which allows for a longer printhead life resulting in fewer printer interruptions for maintenance. Also, the TIJ printhead has a small form factor without sacrificing the print swath provided by the printhead. By eliminating the filter tower and moving the ink filter to adjacent to the cover of the printhead, air handling problems are minimized which also provides for longer printhead life.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. A small form factor printhead comprising;
an ink reservoir body having four side walls connected to a bottom wall,
an ink supply port in the bottom wall,
an ejection head attached to an exterior surface of the bottom wall, wherein the ejection head is in ink flow communication with the ink supply port,
a flexible circuit electrically connected to the ejection head and attached to the exterior surface of the bottom wall and an exterior surface of one of the four side walls,
a cover attached to a distal end of the four side walls opposite the bottom wall, and
a filter attached adjacent to an underside of the cover.

2. The small form factor printhead of claim 1, further comprising an ink reservoir refill port is disposed in the cover.

3. The small form factor printhead of claim 1, wherein the filter is adhesively attached to the inside surface of the cover.

4. The small form factor printhead of claim 1, wherein the filter is welded to the inside surface of the cover.

5. The small form factor printhead of claim 1, wherein the filter is attached to the four side walls opposite the bottom wall.

6. The small form factor printhead of claim 1, wherein the filter is selected from the group consisting of a stainless steel mesh, a porous membrane, a random weave polymeric web, a mesh polymeric web, and a polymeric felt.

7. The small form factor printhead of claim 1, wherein the ink reservoir is devoid of a backpressure device.

8. The small form factor printhead of claim 1, wherein the ink reservoir is devoid of a filter tower structure.

9. The small form factor printhead of claim 1, wherein the ink reservoir has a total ink volume ranging from about 4 mL to about 25 mL.

10. The small form factor printhead of claim 1, wherein the ejection head has an ejector array length ranging from about 2 millimeters to about 25 millimeters.

11. A thermal ink jet printer comprising;
a small form factor printhead having:
an ink reservoir body having four side walls connected to a bottom wall,
an ink supply port in the bottom wall,
an ejection head attached to an exterior surface of the bottom wall, wherein the ejection head is in ink flow communication with the ink supply port,
a flexible circuit electrically connected to the ejection head and attached to the exterior surface of the bottom wall and an exterior surface of one of the four side walls,
a cover attached to a distal end of the four side walls opposite the bottom wall,
a filter attached adjacent to an underside of the cover, and
an ink reservoir refill port attached to an exterior surface of the cover;
a bulk ink supply tank in fluid flow communication with the ink reservoir refill port; and
a printhead controller in electrical communication with the small form factor printhead.

12. The thermal ink jet printer of claim 11, further comprising two or more stationary small form factor printheads adjacent to a movable substrate, wherein the two or more stationary printheads are configured for printing on the movable substrate.

13. The thermal ink jet printer of claim 12, wherein each of the two or more stationary small form factor printheads have an ink reservoir having a total ink volume ranging from about 4 mL to about 25 mL.

14. The thermal ink jet printer of claim 12, wherein each of the two or more stationary small form factor printheads has an ejector array length ranging from about 2 millimeters to about 25 millimeters.

15. The thermal ink jet printer of claim 11, wherein the filter is selected from the group consisting of a stainless steel mesh, a porous membrane, a random weave polymeric web, a mesh polymeric web, and a polymeric felt.

16. A small form factor printhead comprising:
an ink reservoir body having an internal void volume ranging from about 4 mL to about 25 mL;
a top cover attached to the ink reservoir body, the top cover having a fluid fill port therein;
a bottom wall attached to the ink reservoir body on a distal end of the ink reservoir body from the top cover, the bottom wall having an ink supply port therein;
an ejection head attached to an exterior surface of the bottom wall, wherein the ejection head is in ink flow communication with the ink supply port;
a flexible circuit electrically connected to the ejection head and attached to the exterior surface of the ink reservoir body; and
a filter attached adjacent to an underside of the top cover.

17. The small form factor printhead of claim 16, wherein the filter is welded to the inside surface of the top cover.

18. The small form factor printhead of claim 16, wherein the filter is selected from the group consisting of a stainless steel mesh, a porous membrane, a random weave polymeric web, a mesh polymeric web, and a polymeric felt.

19. The small form factor printhead of claim 16, wherein the ink reservoir body is devoid of a backpressure device.

20. The small form factor printhead of claim 16, wherein the ink reservoir body is devoid of a filter tower structure.
